(19) United States
(12) Patent Application Publication
(10) Pub. No.: US 2025/0142273 A1
(43) Pub. Date: May 1, 2025

(54) EARPHONES WITH ON-HEAD DETECTION

(71) Applicant: Bose Corporation, Framingham, MA (US)

(72) Inventor: Thomas Landemaine, Cambridge, MA (US)

(73) Assignee: Bose Corporation, Framingham, MA (US)

(21) Appl. No.: 18/495,253

(22) Filed: Oct. 26, 2023

(51) Int. Cl. H04R 29/00; H04R 1/10

(52) U.S. Cl. CPC H04R 29/001; H04R 1/1016; H04R 2430/01

(57) ABSTRACT

A pair of earphones with on-head detection, including: a first earpiece housing a first orientation sensor, the first orientation sensor outputting a first orientation signal representing a first orientation of the first earpiece; a second earpiece housing a second orientation sensor, the second orientation sensor outputting a second orientation signal representing a second orientation of the second earpiece; a controller configured determine an on-head status of the first earpiece and the second earpiece based, at least in part, on whether the first orientation signal and the second orientation signal represent a common change in orientation, wherein the controller is further configured to begin or suspend at least one function of the pair of earphones upon determining a change in the on-head status of at least one the first earpiece or the second earpiece.

### BACKGROUND

This disclosure relates to earphones with on-head detection and a method for detecting when earphones are disposed on the user's head.

### SUMMARY

All examples and features mentioned below can be combined in any technically possible way.

According to an aspect, a pair of earphones with on-head detection, includes: a first earpiece housing a first orientation sensor, the first orientation sensor outputting a first orientation signal representing a first orientation of the first earpiece; a second earpiece housing a second orientation sensor, the second orientation sensor outputting a second orientation signal representing a second orientation of the second earpiece; a controller configured determine an on-head status of the first earpiece and the second earpiece based, at least in part, on whether the first orientation signal and the second orientation signal represent a common change in orientation, wherein the controller is further configured to begin or suspend at least one function of the pair of earphones upon determining a change in the on-head status of at least one the first earpiece or the second earpiece.

In an example, the first orientation signal comprises a first vector of angular rates, wherein the second orientation signal comprises a second vector of angular rates, wherein determining whether the first orientation signal and the second orientation signal represents a common change in orientation comprises determining whether a difference between a norm of the first vector of angular rates and a norm of the second vector of angular rates exceeds a threshold.

In an example, determining whether the first orientation signal and the second orientation signal represents a common change in orientation comprises determining whether a difference between a rotation step of the first orientation signal and the rotation step of the second orientation signal exceeds a threshold.

In an example, determining a difference between a rotation step of the first orientation signal and the rotation step of the second orientation signal comprises comparing a rotation angle of the first orientation signal and a rotation angle of the second orientation signal.

In an example, the first orientation signal comprises data representing a quaternion characterizing the first orientation, wherein the second orientation signal comprises data representing a quaternion characterizing the second orientation, wherein determining whether a difference between a rotation step of the first orientation signal and the rotation step of the second orientation signal exceeds a threshold comprises determining whether a difference between a change in orientation of a known axis of the first orientation sensor and a change in a known axis of the second orientation sensor exceeds a threshold.

In an example, beginning or suspending at least one function of the pair of earphones comprises suspending audio playback upon determining a change in the on-head status, from on-head to off-head, of at least one of the first earpiece or the second earpiece.

In an example, beginning or suspending at least one function of the pair of earphones comprises beginning a transparency mode in the first earpiece upon determining the change in the on-head status, from on-head to off-head, of the second earpiece.

In an example, the controller is configured to determine which of the first earpiece and the second earpiece has changed from on-head to off-head according to which of a change in the first orientation signal and a change in the second orientation signal, over a period of time, is larger.

In an example, beginning or suspending at least one function of the pair of earphones comprises beginning a pending call upon determining the change in the on-head status, from off-head to on-head, of at least one of the first earpiece or the second earpiece.

In an example, determining an on-head status of the first earpiece and the second earpiece is further based on input from a sensor.

According to another aspect, a method for detecting whether a pair of earphones are disposed on a user's head, includes: receiving a first orientation signal from a first orientation sensor representing an orientation of a first earpiece; receiving a second orientation signal from a second orientation sensor representing an orientation of a second earpiece; determining an on-head status of the first earpiece and the second earpiece based, at least in part, on whether the first orientation signal and the second orientation signal represent a common change in orientation; and beginning or suspending at least one function of the pair of earphones upon determining a change in the on-head status of at least one the first earpiece or the second earpiece.

In an example, the first orientation signal comprises a first vector of angular rates, wherein the second orientation signal comprises a second vector of angular rates, wherein determining whether the first orientation signal and the second orientation signal represents a common change in orientation comprises determining whether a difference between a norm of the first vector of angular rates and a norm of the second vector of angular rates exceeds a threshold.

In an example, determining whether the first orientation signal and the second orientation signal represents a common change in orientation comprises determining whether a difference between a rotation step of the first orientation signal and the rotation step of the second orientation signal exceeds a threshold.

In an example, determining a difference between a rotation step of the first orientation signal and the rotation step of the second orientation signal comprises comparing a rotation angle of the first orientation signal and a rotation angle of the second orientation signal.

In an example, the first orientation signal comprises data representing a quaternion characterizing the first orientation, wherein the second orientation signal comprises data representing a quaternion characterizing the second orientation, wherein determining whether a difference between a rotation step of the first orientation signal and the rotation step of the second orientation signal exceeds a threshold comprises determining whether a difference between a change in orientation of a known axis of the first orientation sensor and a change in a known axis of the second orientation sensor exceeds a threshold.

In an example, beginning or suspending at least one function of the pair of earphones comprises suspending audio playback upon determining a change in the on-head status, from on-head to off-head, of at least one of the first earpiece or the second earpiece.

In an example, beginning or suspending at least one function of the pair of earphones comprises beginning a transparency mode in the first earpiece upon determining the change in the on-head status, from on-head to off-head, of the second earpiece.

In an example, the method further includes determining which of the first earpiece and the second earpiece has changed from on-head to off-head according to which of a change in the first orientation signal and a change in the second orientation signal, over a period of time, is larger.

In an example, beginning or suspending at least one function of the pair of earphones comprises beginning a pending call upon determining the change in the on-head status, from off-head to on-head, of at least one of the first earpiece or the second earpiece.

In an example, determining an on-head status of the first earpiece and the second earpiece is further based on input from a sensor.

The details of one or more implementations are set forth in the accompanying drawings and the description below. Other features, objects, and advantages will be apparent from the description and the drawings, and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various aspects.

FIG. 1 depicts a block diagram of a pair of earphones, according to an example.

FIG. 2A depicts a front view and the associated axes of a human head.

FIG. 2B depicts a top view and the associated axes of a human head.

FIG. 3A depicts a front view and the associated axes of a pair of earbuds.

FIG. 3B depicts a top view and the associated axes of a pair of earbuds.

FIG. 4A depicts a method for detecting when earphones are disposed on the user's head, according to an example.

FIG. 4B depicts a part of a method for detecting when earphones are disposed on the user's head, according to an example.

FIG. 4C depicts a part of a method for detecting when earphones are disposed on the user's head, according to an example.

FIG. 4D depicts a part of a method for detecting when earphones are disposed on the user's head, according to an example.

FIG. 4E depicts a part of a method for detecting when earphones are disposed on the user's head, according to an example.

### DETAILED DESCRIPTION

Certain earphones, such as the Bose QuietComfort Earbuds, feature in-ear detection, which employs a capacitive sensor to detect when the earphones are positioned within the user's ears. These earphones can suspend one or more features, such as audio playback, or active noise reduction, if the earbuds are detected as being removed the user's ears. Alternatively, the earphones can begin a feature, such as entering transparency mode if one earbud is detected as removed. Further, if the earbuds are detected as being inserted while a call is pending, the call can automatically be answered.

For earbuds or in-ear earphones, the capacitive sensor can be positioned within the headphone casing to reliably detect when the earpiece is positioned in the user's ear. However, for other earphones form factors, such as open-ear wearables, it can be difficult to similarly position a sensor that reliably detects the on-head status of the headphone, as no part of the open-ear wearable consistently contacts users' skin, given variations in user's ear shapes and the positioning adjustments made to the earpieces during use.

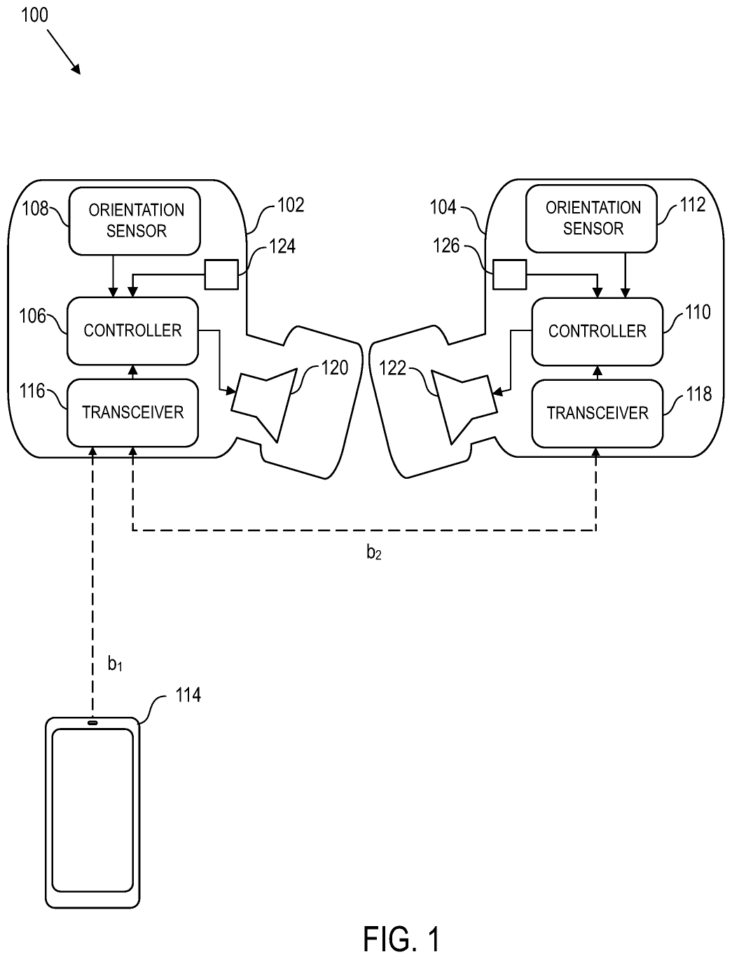

Turning to FIG. 1, there is shown a block diagram of a pair of earphones 100 with on-head detection determined according to the output of orientation sensors within the earpieces (thus not relying on a capacitive sensor or other sensor that depends on contact or proximity to the user's skin). Earphones 100 comprise left earpiece 102 and right earpiece 104. Left earpiece 102 includes a controller 106 in communication with an orientation sensor 108, which detects an orientation of the left earpiece 102 and outputs an orientation signal, representative of the detected orientation, to controller 106. The orientation can be measured in the instantaneous sensor frame (e.g., gyroscope signals or accelerometer signals), i.e., the measurement is relative to the axes of orientation sensor 108. In other words, the orientation sensor 108 does not necessarily provide an absolute orientation, but a relative orientation that is given in terms of changes with respect to the orthogonal axes of orientation sensor 108 as it rotates in space. Alternatively, however, orientation can be given relative to fixed axes. For example, a quaternion is typically constructed by integrating the gyroscope signal (and fusing the result with the accelerometer signal to correct for drift of roll and pitch). Therefore, the quaternion signal encodes and absolute orientation of the moving orientation sensor axes relative to fixed axes (a set of axes chosen at the start of integration). Likewise, right earpiece 104 includes a controller 110 in communication with an orientation sensor 112, which detects and reports an orientation signal, representing the orientation of the right earpiece 104, to controller 106. The orientation signal output from orientation sensor 112 is also similarly provided to controller 110 relative to the axes of orientation sensor 112 or relative to a fixed axes.

In the example of FIG. 1, left earpiece 102 and right earpiece 104 receive an audio signal from a source such as a mobile device 114 (although other suitable sources are contemplated). The audio signal is received at left earpiece 102, over wireless connection b₁ (e.g., a Bluetooth connection) at transceiver 116, which provides the audio signal to controller 106. Transceiver 116 further relays the audio signal to transceiver 118, via wireless connection b₂ which provides the audio signal to controller 110. (In alternative examples, transceivers 116, 118 can each receive the wireless signal directly from the source, rather than relying on an earpiece to relay the signal to the other earpiece.) Controller 106 drives electroacoustic transducer 120 according to the audio signal received at transceiver 116, and controller 110 drives electroacoustic transducer 122 according to the audio signal received at transceiver 118. Controller 106 and controller 110 can drive electroacoustic transducers 120, 122 in a manner that provides a spatialized acoustic signal to the user, based on the orientation of the user's head detected by orientation sensors 108, 112. Controller 106 and controller 110 can further implement functions such as active noise reduction, transparency mode (sometimes referred to as “hear-through” mode), answering calls received at mobile device 114, etc. In general, these features, including the production of spatialized audio from an orientation signal, active noise reduction, transparency mode, and answering calls, is known and so a detailed explanation is omitted here.

For the purposes of this disclosure, the term “earphones” refers to any headphones that are not tied to rigid body constraints when not mounted to the user's head. “Earphones” thus includes form factors such as open-ear wearables, in-ear headphones, and earbuds. (It should be recognized that on-head detection using orientation sensors can be used in form factors even where a sensor could otherwise be placed to detect when the earpieces are worn.) Further, for the purposes of simplicity and to emphasize the more relevant aspects of earphones 100, certain features of the block diagram of FIG. 1 have been omitted, such as, for example, a battery, indicator LEDs, external buttons/inputs, feedback microphones, feedforward microphones, etc.

In addition, although a wireless connection to source 114, and between earpieces 102, 104 is described, in other examples, a wired connection can be used. The wired connection can, for example, connect to mobile device 114, or it can connect only earpieces 102, 104 together, such as within a neckband. To the extent that a wireless connection is used, any suitable wireless protocol can be employed. While Bluetooth or DECT are typically the standards used for wireless headphone connections, it is conceivable that other standards or a proprietary standard could be used. Transceivers 116, 118 can be implemented as wireless modules of the appropriate proprietary standard. For example, transceivers 116, 118 can each be implemented as a Bluetooth system-on-chip.

As described above, the on-head detection can be performed according to the output of orientation sensors 108, 112. More particularly, when both earpieces 102 and 104 are mounted on the user's head, their motion is tied by rigid body constraints. Accordingly, agreement between the orientation signals output from orientation sensor 108 and orientation sensor 112 indicates that earpieces 102, 104 are mounted to the user's head. Thus, the on-head status of the earpiece 102 and earpiece 104 can be determined based, at least in part, on whether the signals from orientation sensor 108 and orientation sensor 112 represent common changes in orientation, indicating they are attached to the same rigid body (the user's head). For example, whether earpieces 102, 104 are mounted on the user's head can be determined according to whether a difference in the change in orientation of orientation sensor 108 and the change in orientation of orientation sensor 112, as measured by the sensors and encoded in the output signals, exceeds a threshold. Alternatively, the signal can represent common changes in orientation without encoding the orientation itself. For example, the signal representing the change in orientation can be a signal that represents a value from which a change in orientation can be determined, such as an angular velocity (e.g., as output from a gyroscope sensor). Thus, whether earpieces 102, 104 are mounted on the user's head can be determined according to whether the difference in changes in a magnitude of angular velocity of orientation sensor 108 and orientation sensor 112 exceeds a threshold.

Upon determining that the difference does not exceed the threshold (which can be a fixed value, a percentage of the signal magnitude, or a combination of the two), the on-head status of both earpieces 102, 104 can be set to “on-head” (i.e., the user is wearing the earphones 100). Conversely, upon determining that the difference does exceed the threshold, the on-head status of one or both earpieces 102, 104 can be set to “off-head” (i.e., the user is not wearing the earphones 100). It should be understood that the angular velocity magnitude can be used as received from the gyroscope sensors, or some filtering or operations can be performed over multiple frames of data for example, before comparing to the threshold.

Further, following a change in on-head status, it can be determined which earpiece has been removed according to which orientation signal demonstrated the largest “jump.” In other words, the change in orientation represented in the orientation signals from orientation sensors 110, 112 can be measured, and the orientation signal that represents the larger change in orientation can be determined to correspond to the removed earpiece 102, 104.

In addition, at least one function of earphones 100 can be suspended or begun in response to a change in the on-head status of at least one of the earpieces 102, 104. For example, audio playback can be suspended upon determining a change in the on-head status, from on-head to off-head, of at least one of earpieces 102, 104. Alternatively, or additionally, upon determining that one earpiece 102, 104 has been removed (e.g., earpiece 102)—that is the on-head status changed from “on-head” to “off-head”—the remaining earpiece (e.g., earpiece 104) can be set to transparency mode and/or have active noise reduction disabled or reduced. Further, if a call is pending (e.g., on mobile device 114), the call can be begun (i.e., answered) upon determining the change in on-head status from “off-head” to “on-head” of earpieces 102, 104, indicating that the user has put earpieces 102, 104 on to answer the call.

For the purposes of this disclosure, a controller includes one or more processors, one or more non-transitory storage media storing program code (including, for example, the steps of method 400), and any associated hardware for performing the various functions described in this disclosure. In an example, a controller can comprise a microcontroller, which includes a processor and a non-transitory storage media. The controller can also comprise multiple microcontrollers acting in concert to perform the various functions described. Thus, in the example of FIG. 1, each of controller 106, 110 includes at least one processor and non-transitory storage medium storing program code that, when executed by the processor(s), provides the spatialized audio to acoustic transducers 116, 118, according to the outputs of orientation sensors 108, 112.

The on-head detection using described in this disclosure, including the steps of method 400, can be performed by any suitable controller of earphones 100. Thus, in an example, on-head detection can be performed by controller 106 or by controller 110. Indeed, the on-head detection can be performed by a combination of controllers 106 and 110 acting in concert. In this example, controllers 106 110, working together, can be considered a single controller distributed between earpieces 102, 104. Further, in certain examples, the controller can be located outside of earpieces 102, 104. For example, in wired examples, a down-cable controller can perform the on-head detection. Indeed, it is conceivable that the on-head detection could be performed, at least in part, by a controller located outside of earphones 100, such as by mobile device 114, or even a remote server accessed over an internet connection.

Orientation sensors 108, 112 can be any comprised of any sensor or sensors outputting data from which an orientation of the sensor—i.e., the three-dimensional axes of the sensor representing the sensor's orientation in space—can be determined. In an example, each orientation sensor 108, 112 can be an inertial measurement unit (IMU). An inertial measurement unit is a sensor that typically comprises accelerometers, gyroscopes, and sometimes magnetometers and outputs an orientation, acceleration, and angular velocity. An inertial measurement unit is, however, only one example of a suitable orientation sensor. In alternative examples, the orientation sensors can each comprise a plurality of gyroscope sensors, each gyroscope sensor outputting angular rate data in at least one axis, such that the angular rate of the earpiece in three dimensions can be determined.

Further, the orientation sensor in each earpiece need not be the same type of sensor, although additional processing can be required where different types of orientation sensor are used in each earpiece in order to compare the signals. For example, if the left earpiece 102 has only a gyroscope, whereas a quaternion is available from an inertial measurement unit in right earpiece 104, the angular velocity can be estimated from the quaternion and compared to the angular velocity of the gyroscope on the left. Alternatively, the rotation of the left earpiece 102 could be estimated from the gyroscope and compared to the rotation of from the quaternion output from the inertial motion sensor of the right earpiece 104.

As mentioned above, each orientation sensor 108, 112 provides orientation data that measures changes relative to its axes or relative to a fixed orientation. For example, the orientation signal can comprise data encoding a vector of angular rates. The vector of angular rates represents the change in orientation at given moment in time, i.e., the how quickly the orientation sensor is rotating about each of its three orthogonal axes (X, Y, and Z). In various alternative examples, the orientation signal can comprise data encoding a rotation vector, a game rotation vector, a geomagnetic rotation vector, or a quaternion. These forms will be understood and so a more detailed explanation of each is omitted here.

The orientation represented by the orientation signals of orientation sensors 108, 112 is not provided with respect to common axes. In other words, with limited exception, orientation sensor 108 and orientation sensor 112 do not have the same axes and include offsets between the axes, and thus the orientations cannot be directly compared to determine if earpieces 102, 104 are mounted to a rigid body. This problem can be addressed, however, by isolating common changes in orientation, regardless of sensor axes or coordinate system. For example, isolating common changes in orientation can include monitoring the norm of the angular velocity magnitude recorded by sensors 108, 112 or monitoring rotation steps recorded by sensors 108, 112.

In a first example, if the orientation signals each include data representing a vector of angular rates (e.g., gyroscopes are used as the orientation sensors 108, 112), the difference between the norms of the vectors of angular rates can be used to determine if orientation sensors 108, 112 are experiencing common changes in orientation. The norms of each vector represent the magnitude of the angular velocity without requiring knowledge of either sensor axes or how they map to one another. By observing whether the norms are similar over multiple samples, it can be determined with a high degree of certainty that orientation sensors 108, 112 are mounted on a rigid body. In an example, to determine whether the norms are sufficiently similar, a difference between the norms can be compared to a threshold.

For example, the orientation data of the orientation sensor 108, for a single sample, can be represented as

$${ω}_{L} [ n ] = [ \begin{matrix}{ω}_{L , x} [ n ] \\ {ω}_{L , y} [ n ] \\ {ω}_{L , z} [ n ]\end{matrix} ] \qquad ( 1 )$$

where ω_{L}[n], the orientation data of orientation sensor 108, is a three-dimensional vector of angular rates including the angular rates in the direction of the x-axis ω_{L,x}[n], in the direction of the y-axis ω_{L,y}[n], and in the direction of the z-axis ω_{L,z}[n]. The norm of vector ω_{L}[n] can be found as:

$$\vert {ω}_{L} [ n ] \vert = \sqrt{{{ω}_{L , x} [ n ]}^{2} + {{ω}_{L , y} [ n ]}^{2} + {{ω}_{L , z} [ n ]}^{2}} \qquad ( 2 )$$

In the same way, the orientation data of the orientation sensor 108, for a single sample, can be represented as:

$${ω}_{R} [ n ] = [ \begin{matrix}{ω}_{R , x} [ n ] \\ {ω}_{R , y} [ n ] \\ {ω}_{R , z} [ n ]\end{matrix} ] \qquad ( 3 )$$

where ω_{R} [n], the orientation data of orientation sensor 112, is a three-dimensional vector of angular rates including the angular rates in the direction of the x-axis ω_{R,x}[n], in the direction of the y-axis ω_{R,y}[n], and in the direction of the z-axis ω_{R,z}[n]. Likewise, the norm of ω_{R}[n] can be found as:

$$\vert {ω}_{R} [ n ] \vert = \sqrt{{{ω}_{R , x} [ n ]}^{2} + {{ω}_{R , y} [ n ]}^{2} + {{ω}_{R , z} [ n ]}^{2}} \qquad ( 4 )$$

The difference between the norm |ω_{L}[n]| of the orientation data of orientation sensor 108 and the norm |ω_{R} [n]| of the orientation data of orientation sensor 112 can be compared to a threshold, ε_{onhead} as follows:

$$\vert \vert {ω}_{L} [ n ] \vert - \vert {ω}_{R} [ n ] \vert \vert < {ε}_{o n h e a d} \qquad ( 5 )$$

Here, if difference is greater than the threshold ε_{onhead} it can be assumed that the magnitudes of the angular vectors represented in the orientation signals of orientation sensors 108, 112 are sufficiently different to preclude earpieces 102, 104 being on the user's head. However, a difference less than threshold ε_{onhead} means that the magnitudes are sufficiently similar to indicate that earpieces 102, 104 are disposed on the user's head. This calculation can be repeated for multiple samples before the on-head status is set to “on-head,” to rule out any consistent but transient motions of the earpieces that might incorrectly suggests that the earpieces 102, 104 are on the user's head during a single sample.

For the purposes of this disclosure, the degree of similarity required to determine that a change in orientation is common to both orientation sensors 108, 112 (e.g., the value of ε_{onhead}) is a design choice that considers sensor tolerances and the desired confidence of on-head detection.

In an alternative example, as mentioned above, rotation steps recorded by sensors 108, 112 can be compared in order to detect agreement between the outputs, without regard to sensor axes or coordinate system. For example, if the output is provided as a quaternion, the step quaternion dqL of the data output from orientation sensor 108 can first be found by multiplying the quaternion by the conjugate of a quaternion from a previous sample, as follows:

$$dqL = q L * conj ( {qL}_{prev} ) \qquad ( 6 )$$

where qL is the quaternion represented in the orientation data output by orientation sensor 108 and qLₚᵣₑᵥ is the quaternion represented in a previous (e.g., most recent) sample. In the same way, the step quaternion dqR can be found for the quaternion qR represented in the orientation data of orientation sensor 112:

$$dqR = qR * conj ( {qR}_{prev} ) \qquad ( 7 )$$

where qR is the quaternion represented in the orientation data output by orientation sensor 112 (e.g., in a current sample) and qRₚᵣₑᵥ is the quaternion represented in a previous (e.g., most recent) sample. (It is necessary, in this example, that qR and qL are from the same time sample and, likewise, qLₚᵣₑᵥ and qRₚᵣₑᵥ are from the same time sample.)

In particular, building on Eq. (6), the step quaternion dqL can be found as follows:

$$dqL = qL * conj ( {qL}_{prev} ) = [ cos ( \frac{Δ {θ}_{L}}{2} ) , sin ( \frac{Δ {θ}_{L}}{2} ) {u}_{L} ] \qquad ( 8 )$$

where, u_{L} is a unit vector (the rotation axis for the rotation encoded by dqL) and ΔθB_{L} is the angle of rotation. Likewise, building on Eq. (7), the step quaternion dqR can be found as:

$$dqR = qR * conj ( {qR}_{prev} ) = [ cos ( \frac{Δ {θ}_{R}}{2} ) , sin ( \frac{Δ {θ}_{R}}{2} ) {u}_{R} ] \qquad ( 9 )$$

where, u_{R} is a unit vector (the rotation axis for the rotation encoded by dqR) and Δθ_{R} is the angle of rotation.

If the rigid body condition is met, (i.e., earpiece 102, 104 are both attached to a rigid body, such as the user's head), the angle of rotation from Eqs. 8 and 9 will be approximately equal, and thus:

$$Δ {θ}_{R} \approx Δ {θ}_{L} \to sin ( \frac{Δ {θ}_{R}}{2} ) \approx sin ( \frac{Δ {θ}_{L}}{2} ) \qquad ( 10 )$$

The rigid body condition can therefore be checked by determining whether the difference between the angles of rotation is less than a threshold. This can be accomplished, for example, by determining whether a difference between the left and right step quaternions of consecutive (or otherwise sequential) samples exceeds a threshold. Because |u_{R}|=|u_{L|}=1, this expression can be rewritten as:

$$\vert sin ( \frac{Δ {θ}_{R}}{2} ) {u}_{R} \vert \approx \vert sin ( \frac{Δ {θ}_{L}}{2} ) {u}_{L} \vert \qquad ( 11 )$$

And because:

$$sin ( \frac{Δ {θ}_{L}}{2} ) {u}_{L} = [ dqL ( 2 ) , dqL ( 3 ) , dqL ( 4 ) ] , and \qquad ( 12 )$$

$$sin ( \frac{Δ {θ}_{R}}{2} ) {u}_{R} = [ dqR ( 2 ) , dqR ( 3 ) , dqR ( 4 ) ] , \qquad ( 13 )$$

another way to write the rigid body condition is:

$$\vert \vert [ dqR ( 2 ) , dqR ( 3 ) , dqR ( 4 ) ] \vert - \vert [ dqL ( 2 ) , dqL ( 3 ) , dqL ( 4 ) ] \vert \vert < {ε}_{o n h e a d} \qquad ( 14 )$$

where the argument n of dqL(n) and dqR(n) represent sample numbers. In other words, equation (14) represents the difference between the step quaternions of consecutive samples. Although the axes are different, the change in rotation angle between sensors 108, 112 will be the same or close. The left and right angles of rotation—e.g., as shown in Eq. (10)—can be compared in any suitable manner, and that method described in connection with Eqs. (11)-(14) is one example of a method for such a comparison.

Again, if the difference is greater than the threshold ε_{onhead}, it can be assumed that the step quaternions dqL and dqR are sufficiently different to preclude earpieces 102, 104 being on the user's head. However, a difference less than threshold ε_{onhead} means that step quaternions dqL and dqR are sufficiently similar to indicate that earpieces 102, 104 are disposed on the user's head. This calculation can be repeated for multiple samples or sets of samples before the on-head status is set to “on-head,” to rule out any consistent but transient motions of the earpieces that might incorrectly suggests that the earpieces 102, 104 are on the user's head during a single sample.

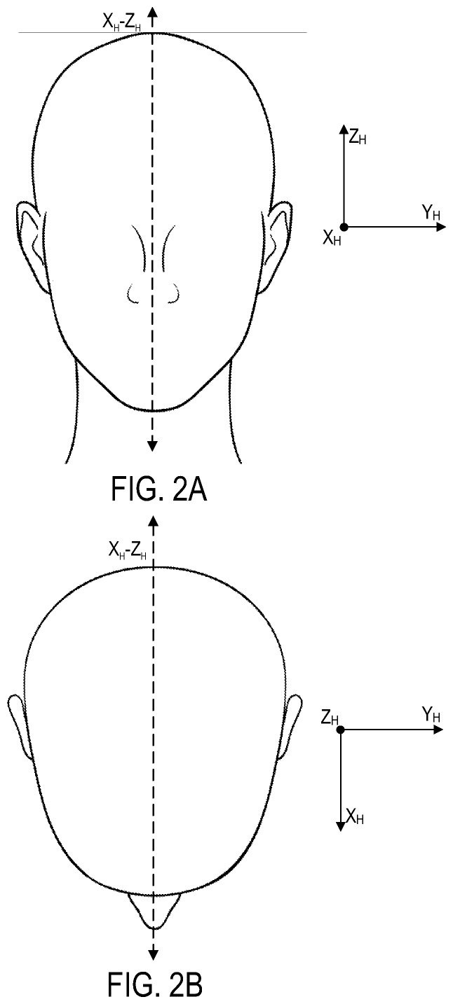

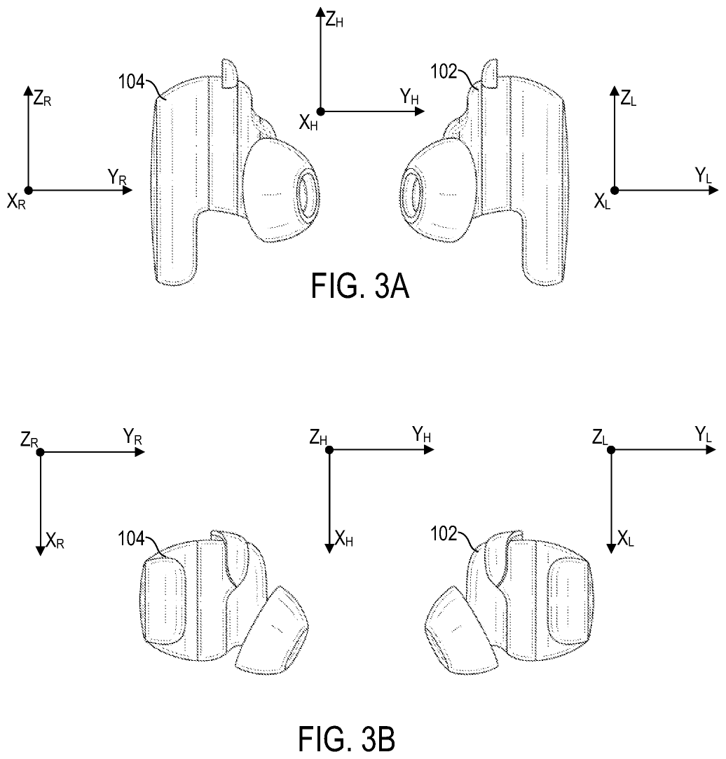

As described above, in an example, orientation sensors 108, 112 can each be implemented as inertial measurement units. Specifically, for a 6-axis inertial measurement unit, the gravity vector is known from accelerometer measurements. The quaternion output of each IMU encodes a rotation from a set of initial axes (in a previous sample) to the current sensor axes. In this case, for both the left orientation sensor 108 and the right orientation sensor 112, the initial frame will share the axis directed along gravity, about which the user's head rotates in yaw. This axis is shown in front and top views of a user's head in FIGS. 2A, 2B as the Z_{H} axis. The corresponding axes of earpieces 102, 104 (here, shown as a pair of Bose QuietComfort Earbuds II) are Z_{L} of earpiece 102 and Z_{R} of earpiece 104. (The user's head axes are reproduced in FIGS. 3A and 3B for reference.) This means that the Z axis coordinates in the coordinate systems of orientation sensors 108, 112 are both known.

Thus, the amount of rotation (i.e., rotation angle) around the known Z axis encoded in the orientation signals of orientations 108, 112 can be compared to determine whether orientation sensors 108, 112 are attached to a rigid body. While the user's head rotates freely, the head rotation, as encoded in the orientation signals, can be decomposed (e.g., with a twist-swing decomposition) as rotation around a known axis (typically along gravity) and a residual rotation. The rotation angle that results from this decomposition can be compared.

Thus, for example, using a twist-swing decomposition, the step quaternions in the Z-axis dqL_{z} and dqR_{z} can be found from the step quaternions in Eqs. (6) and (7). Once the step quaternions dqL_{z} and dqR_{z} in the Z-axis are found, the difference between the step quaternions dqL_{z} and dqR_{z} can be compared to a threshold as follows:

$$\vert {dqR}_{Z} \cdot conj ( {dqL}_{Z} ) - [ 1000 ] \vert < {ε}_{onear} \qquad ( 15 )$$

As described above, if the difference is greater than the threshold ε_{onhead}, it can be assumed that the step quaternions in the Z-axis dqL_{z} and dqR_{z} are sufficiently different to preclude earpieces 102, 104 being on the user's head. However, a difference less than threshold ε_{onhead} means that step quaternions in the Z-axis dqL_{z} and dqR_{z} are sufficiently similar to indicate that earpieces 102, 104 are disposed on the user's head. This calculation can be repeated for multiple samples or sets of samples before the on-head status is set to “on-head,” to rule out any consistent but transient motions of the earpieces that might incorrectly suggests that the earpieces 102, 104 are on the user's head during a single sample.

If earpieces 102, 104 are stationary, such as resting on a surface like a table, then the rigid body condition can technically be met, which could falsely trigger the on-head condition. To address this, the output of orientation sensors 108, 112 could be monitored to ensure that there is some amount of motion, which would be expected if the earpieces 102, 104 were disposed on the user's head. For example, the output of both sensors could be compared to a threshold, such as:

$$\vert {ω}_{L} [ n ] \vert > {ε}_{s t a tionary} AND \vert {ω}_{R} [ n ] \vert > {ε}_{s t a tionary} \qquad ( 16 )$$

where ε_{stationary} is a low threshold set to determine whether any motion is detected by orientation sensors 108, 112. If quaternions are used, equation (9) becomes:

$$\vert dqL - [ 1000 ] \vert > {ε}_{stationary} AND \vert qdR - [ 1000 ] \vert > {ε}_{s t a tionary} \qquad ( 17 )$$

In general, threshold ε_{stationary} can be set low enough to detect any motion that could be expected on the user's head, but not on a stationary surface, including, for example, jitter.

Additionally, if earpieces 102, 104 are in the user's pocket (or in any other place where the earpieces 102, 104 are moving together), then the rigid body condition can be met even when earpieces 102, 104 are not positioned on the user's head. Further, because earpieces 102, 104 are in motion, this case cannot be resolved relying on Eqs. (9) or (10), and the discussion above. Accordingly, an additional sensor, such as sensor 124 and 126 in FIG. 1 can be used to determine if the user is wearing earpieces 102, 104. For example, sensors 124, 126 can be capacitive sensors that detect contact with the user's skin. Because orientation sensors 108, 112 are already used to detect the on-head condition, it is not necessary that sensors 124, 126 maintain consistent contact with the user's skin. Instead, even irregular contact can confirm the that the user is wearing earpieces 102, 104.

However, if the user is carrying both earpieces 102, 104 in the same hand, sensors 124, 126 could feasibly detect skin contact and meet the rigid body constraint. To address this, in addition to monitoring the orientation signals of orientation sensors 108, 112 for the rigid body constraint, the yaw axis (e.g., the Z_{L} and Z_{R} axes as shown in FIGS. 3A and 3B) can be compared against the gravity vector, as can be determined from certain orientation sensors such as inertial measurement units. If the yaw axis is within some predetermined angle of the gravity vector (i.e., the gravity vector is within a cone from yaw axis), it can be assumed that earpieces 102, 104 are worn on the user's head. The predetermined angle is a design choice that takes into account the variable ways that users often position earpieces within ears, and which adjust the yaw axis relative to the gravity vector. Comparing the yaw axis to the gravity vector can obviate the need for sensor 124, 126 described above.

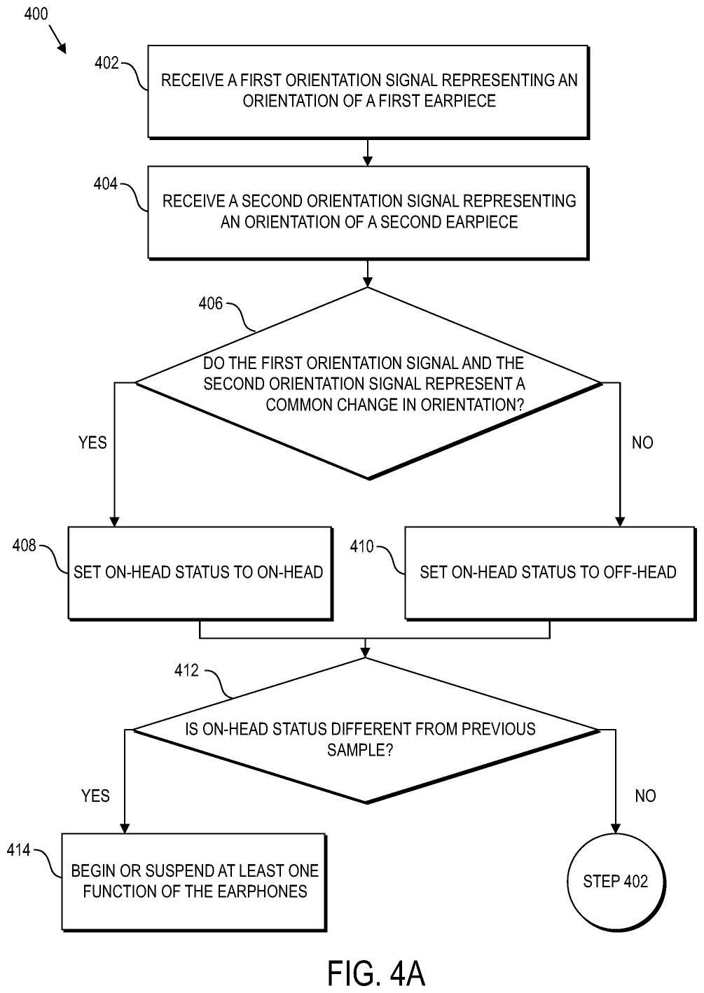

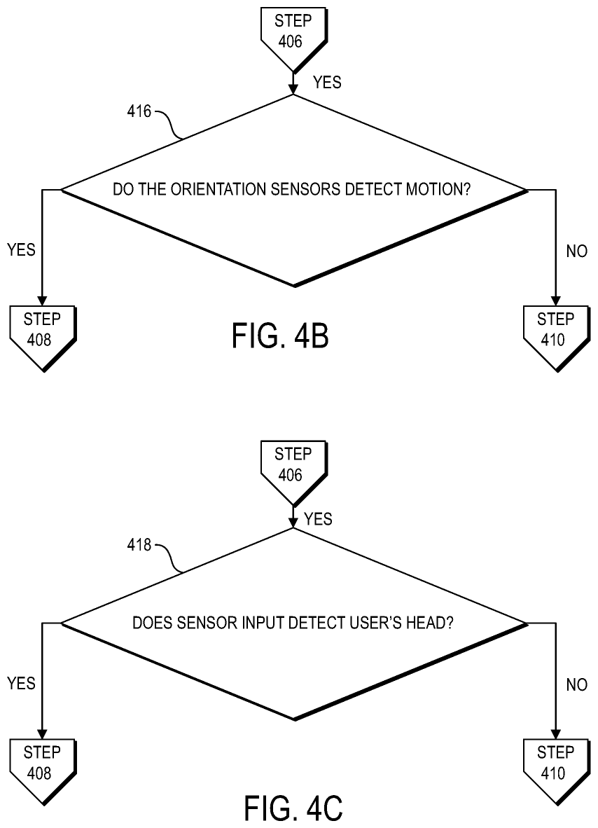

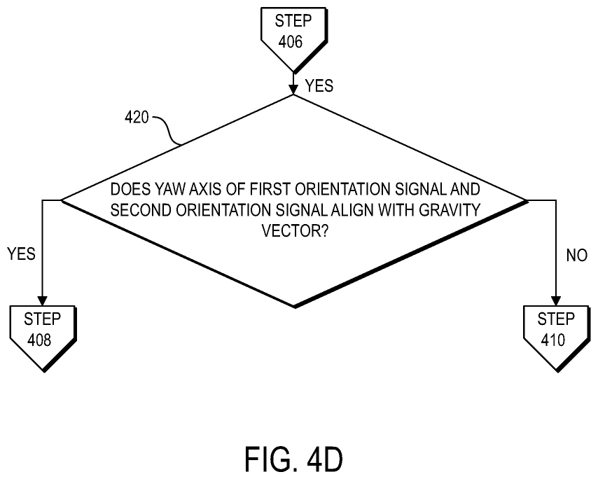

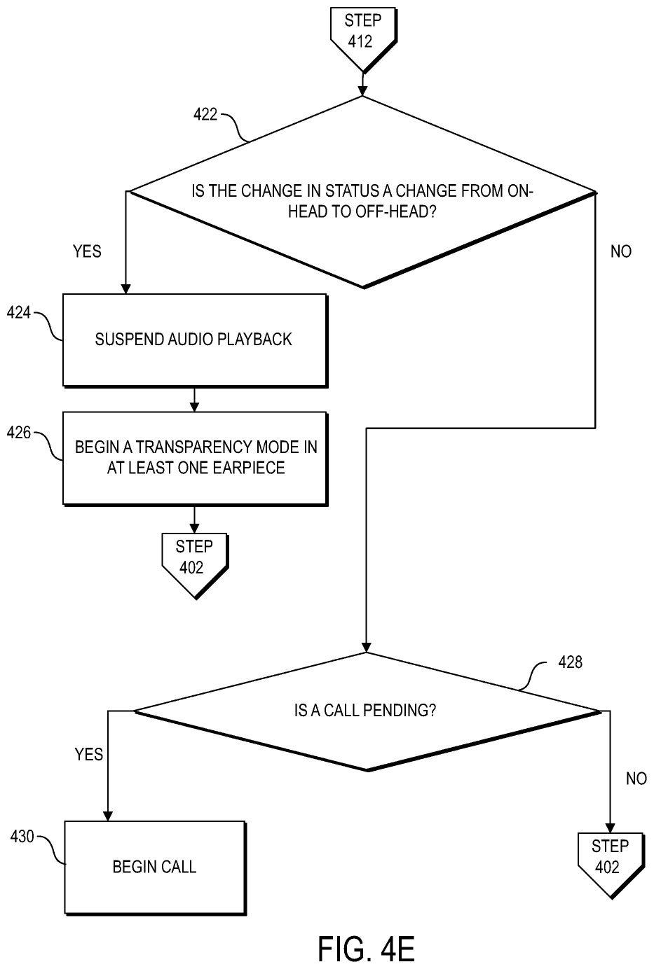

Turning now to FIG. 4, there is shown a flowchart of a method for on-head detection of earphones. The steps of method 400 can be accomplished by a controller as described above, such as controllers 106, 110 or a controller that is comprised of both controllers 106, 110 acting in concert. As such, in an example, the steps of method 400 can be accomplished by a one or more processors executing program code stored in one or more non-transitory storage media. For the purposes of this method, the earpieces will be described as a “first” and a “second” earpiece. This is to emphasize that the method does not depend on either the left or right earpieces performing a particular step. Thus, the left earpiece can be the first earpiece and the right the second; alternatively, the right earpiece can be the first earpiece and the left the second.

At step 402, a first orientation signal representing an orientation of a first earpiece is received. The first orientation signal is received from an orientation sensor disposed in a first earpiece. At step 404, receive a second orientation signal representing an orientation of a second earpiece. The second orientation signal is received from an orientation sensor disposed in a second earpiece.

The first and second orientation sensors, as described above, can be any comprised of any sensor or sensors outputting data from which an orientation of the sensor—i.e., the three-dimensional axes of the sensor representing the sensor's orientation in space—can be determined. Examples of sensors include inertial measurement units or a plurality of gyroscope sensors.

The orientation signals can comprise data representative of the orientation of the orientation sensor (and the earpiece to which it is attached) directly, e.g., as changes in pitch, roll, and yaw, or can contain other data from which orientation can be derived, such as the specific force and angular rate of the orientation sensor. To the extent that the orientation sensor is comprised of multiple sensors, it should be understood that the orientation signal can comprise multiple signals. In various alternative examples, the orientation signal can comprise data encoding a rotation vector, a game rotation vector, a geomagnetic rotation vector, or a quaternion.

Step 406 is a decision block that determines whether the first orientation signal and the second orientation signal represent a common change in orientation. This decision block is determining whether there is sufficient agreement between the orientation signals to conclude that the earpieces are tied to a rigid body—i.e., moving in unison, attached to the user's head. However, because the orientation sensors in each earpiece do not have the same axes and include offsets between the axes, the orientations cannot be directly compared to determine if the first and second earpieces are mounted to a rigid body. This problem can be addressed by isolating common changes in orientation (regardless of coordinate system or sensor axes).

Thus, in a first example described above in connection with Eqs. (1)-(5)—where the orientation signals comprise data representing a vector of angular rates—the difference between the norms of the vectors of angular rates can compared against a threshold to determine if there is sufficient agreement between the orientation sensors to conclude that the orientation sensors are tied to a rigid body. In other words, as shown in Eq. (5), the difference of the norm of the vector of angular rates from the first orientation sensor and the norm of the vector of angular rates from the second orientation sensor is compared against a threshold. If the difference exceeds the threshold, it can be determined that there is sufficient difference between the magnitudes of the angular rates (regardless of coordinate system or sensor axes) to assume that the orientation sensors, and thus the earpieces, are not disposed on the user's head. If, however, the difference does not exceed the threshold, it can be determined that the orientations of the earpieces are moving in a manner that suggests that are tied by rigid body constraints and are thus likely disposed on the user's head.

In a second example, the difference between rotation steps, such as indicated by angles of rotation over a period of time, can be compared. An example of this is described in connection with Eqs. (6)-(14) above. In an example, the difference between the angles of rotation, as described for example in Eq. (14), can be compared to a threshold by determining whether a difference between the left and right step quaternions of consecutive (or otherwise sequential) samples exceeds a threshold. It should, however, be understood that the left and right angles of rotation be compared in any suitable manner, and that method described in connection with Eqs. (6)-(14) is one example of a method for such a comparison.

The degree of similarity required to determine that a change in orientation is common to both orientation sensors is a design choice that takes into account sensor tolerances and the desired confidence of on-head detection.

In a third example described in connection with Eqs. (15) above, where the orientation sensors are inertial measurement units outputting a quaternion, the difference between changes in the axis that follows gravity (e.g., the axis about which the user's heard rotates in yaw, the Z axis in FIGS. 2 and 3) are known and thus can be compared to a threshold. Thus, the difference between a change in the Z-axis of the first orientation sensor and a change in the Z-axis of the second orientation sensor can be compared to the threshold. (The changes can, for example, be determined over a predetermined period of time.) If the difference exceeds the threshold, it can be determined that there is sufficient difference between the changes of orientation in the Z-axis to assume that the orientation sensors, and thus the earpieces, are not disposed on the user's head. If, however, the difference does not exceed the threshold, it can be determined that the orientations of the earpieces are moving in a manner that suggests that are tied by rigid body constraints and are thus likely disposed on the user's head. The degree of similarity required to determine that a change in orientation is common to both orientation sensors is a design choice that takes into account sensor tolerances and the desired confidence of on-head detection.

Upon determining, at step 406, that the first orientation signal and the second orientation signal represent a common change in orientation (e.g., the differences do not exceed a threshold), then, at step 408, the on-head status of the earpieces can be set to “on-head.” However, upon determining, at step 406, that first orientation signal and the second orientation signal do not represent a common change in orientation (e.g., the differences exceed the threshold), then at step 410 the on-head status of the earpieces can be set to “off-head.”

Step 412 is a decision block that determines whether the on-head status (determined in step 406 and set in steps 408 or 410) is different from a previous sample. In other words: has the on-head status changed from what it was just prior?Upon determining that the status has changed, indicating that the user has just removed one or both the earpieces from the user's head, then at least one function of the earphones can be suspended or begun. As will be described in connection with FIG. 4E, this can entail, for example, suspending audio playback, entering a transparency mode or suspending active noise reduction, or answering a call if one is pending. Upon determining, however, that the on-head status has not changed, then the method can return to step 402 and repeat method 400.

Steps 416-420 shown in FIGS. 4B-4D represent additional steps for determining whether earpieces are disposed on the user's head, presented as additional measures to rule out false positive detections. In other words, the decision block at step 406 is, in certain examples, only one step for determining the on-head status of the earpieces. Thus, step 416, shown in FIG. 4B, is a decision block that follows step 406 (i.e., from the YES path) and determines whether any motion is detected from the orientation sensors (i.e., a rate of change or a change in orientation that would suggest that the earpieces are in motion). If there is no motion detected, although the orientation sensors may be tied to rigid body, the rigid body cannot be the users head, and thus should not result in an on-head decision.

Similarly, step 418, shown in FIG. 4C, is a decision block that determines whether an additional sensor such as a capacitive sensor, detects the user's head (e.g., the user's skin). This can be a different method for ruling out false positive on-head detections, such as instances where the earpieces are carried together in motion, such as the user's pocket. In another example, step 420, shown in FIG. 4D, is a decision block that determines whether the yaw axis aligns with a gravity vector, such as output from an inertial measurement unit. If the yaw axis is within a predetermined degree of the gravity vector (i.e., the gravity vector exists within a cone about the yaw axis) it can be determined that earpieces are positioned upright on the user's head. (The size of the cone is a design choice that can take into account differences in the way that different users position the earpieces on the head.)

Turning to FIG. 4E, steps 422-430 describe different example features that could be suspended or begun upon determining a change in on-head status, determined at step 412. Step 422 is a decision block that determines whether the change in status is from on-head to off-head. Upon determining that the change is from on-head to off-head, i.e., the user has removed at least one earpiece, then, at step 424 audio playback can be suspended. Alternatively, or in combination, a transparency mode can be begun (and/or an active noise reduction can be suspended or reduced) in the earpiece not removed. Thus, if the second earpiece is determined to be removed, the first earpiece can have transparency mode activated and/or active noise reduction suspended or reduced so that the user can hear better. Likewise, if the first earpiece is determined to be removed, the second earpiece can have transparency mode activated and/or active noise reduction suspended or reduced so that the user can hear better. To determine which earpiece has been removed, the orientation sensor that records the greater change in orientation can be assumed to correspond to the removed earpiece.

Upon determining at step 422 that the status change is not from on-head to off-head (stated positively, the status change is from off-head to on-head), step 428 is a decision block that determines whether a call is pending on a connected mobile device. Upon determining that a call is pending, it can be determined that the user has put on the earpieces in order to answer the call, and so the call can be answered (i.e., begun) at step 430. Upon determining that a call is not pending, however, the method can return to step 402.

These are only examples of features that can be begun or suspended. For example, upon determining that the change in status is from off-head to on-head, audio playback can be resumed if it had previously stopped. A person of ordinary skill in the art, in conjunction with a review of this disclosure, will understand that features can likewise be suspended or triggered by a change in the on-head status.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. A pair of earphones with on-head detection, comprising:
a first earpiece housing a first orientation sensor, the first orientation sensor outputting a first orientation signal representing a first orientation of the first earpiece;
a second earpiece housing a second orientation sensor, the second orientation sensor outputting a second orientation signal representing a second orientation of the second earpiece; and
a controller configured determine an on-head status of the first earpiece and the second earpiece based, at least in part, on whether the first orientation signal and the second orientation signal represent a common change in orientation, wherein the controller is further configured to begin or suspend at least one function of the pair of earphones upon determining a change in the on-head status of at least one the first earpiece or the second earpiece.

2. The pair of earphones of claim 1, wherein the first orientation signal comprises a first vector of angular rates, wherein the second orientation signal comprises a second vector of angular rates, wherein determining whether the first orientation signal and the second orientation signal represents a common change in orientation comprises determining whether a difference between a norm of the first vector of angular rates and a norm of the second vector of angular rates exceeds a threshold.

3. The pair of earphones of claim 1, wherein determining whether the first orientation signal and the second orientation signal represents a common change in orientation comprises determining whether a difference between a rotation step of the first orientation signal and the rotation step of the second orientation signal exceeds a threshold.

4. The pair of earphones of claim 3, wherein determining a difference between a rotation step of the first orientation signal and the rotation step of the second orientation signal comprises comparing a rotation angle of the first orientation signal and a rotation angle of the second orientation signal.

5. The pair of earphones of claim 3, wherein the first orientation signal comprises data representing a quaternion characterizing the first orientation, wherein the second orientation signal comprises data representing a quaternion characterizing the second orientation, wherein determining whether a difference between a rotation step of the first orientation signal and the rotation step of the second orientation signal exceeds a threshold comprises determining whether a difference between a change in orientation of a known axis of the first orientation sensor and a change in a known axis of the second orientation sensor exceeds a threshold.

6. The pair of earphones of claim 1, wherein beginning or suspending at least one function of the pair of earphones comprises suspending audio playback upon determining a change in the on-head status, from on-head to off-head, of at least one of the first earpiece or the second earpiece.

7. The pair of earphones of claim 1, wherein beginning or suspending at least one function of the pair of earphones comprises beginning a transparency mode in the first earpiece upon determining the change in the on-head status, from on-head to off-head, of the second earpiece.

8. The pair of earphones of claim 7, wherein the controller is configured to determine which of the first earpiece and the second earpiece has changed from on-head to off-head according to which of a change in the first orientation signal and a change in the second orientation signal, over a period of time, is larger.

9. The pair of earphones of claim 7, wherein beginning or suspending at least one function of the pair of earphones comprises beginning a pending call upon determining the change in the on-head status, from off-head to on-head, of at least one of the first earpiece or the second earpiece.

10. The pair of earphones of claim 1, wherein determining an on-head status of the first earpiece and the second earpiece is further based on input from a sensor.

11. A method for detecting whether a pair of earphones are disposed on a user's head, comprising:
receiving a first orientation signal from a first orientation sensor representing an orientation of a first earpiece;
receiving a second orientation signal from a second orientation sensor representing an orientation of a second earpiece;
determining an on-head status of the first earpiece and the second earpiece based, at least in part, on whether the first orientation signal and the second orientation signal represent a common change in orientation; and
beginning or suspending at least one function of the pair of earphones upon determining a change in the on-head status of at least one the first earpiece or the second earpiece.

12. The method of claim 11, wherein the first orientation signal comprises a first vector of angular rates, wherein the second orientation signal comprises a second vector of angular rates, wherein determining whether the first orientation signal and the second orientation signal represents a common change in orientation comprises determining whether a difference between a norm of the first vector of angular rates and a norm of the second vector of angular rates exceeds a threshold.

13. The method of claim 11, wherein determining whether the first orientation signal and the second orientation signal represents a common change in orientation comprises determining whether a difference between a rotation step of the first orientation signal and the rotation step of the second orientation signal exceeds a threshold.

14. The method of claim 13, wherein determining a difference between a rotation step of the first orientation signal and the rotation step of the second orientation signal comprises comparing a rotation angle of the first orientation signal and a rotation angle of the second orientation signal.

15. The method of claim 13, wherein the first orientation signal comprises data representing a quaternion characterizing the first orientation, wherein the second orientation signal comprises data representing a quaternion characterizing the second orientation, wherein determining whether a difference between a rotation step of the first orientation signal and the rotation step of the second orientation signal exceeds a threshold comprises determining whether a difference between a change in orientation of a known axis of the first orientation sensor and a change in a known axis of the second orientation sensor exceeds a threshold.

16. The method of claim 11, wherein beginning or suspending at least one function of the pair of earphones comprises suspending audio playback upon determining a change in the on-head status, from on-head to off-head, of at least one of the first earpiece or the second earpiece.

17. The method of claim 11, wherein beginning or suspending at least one function of the pair of earphones comprises beginning a transparency mode in the first earpiece upon determining the change in the on-head status, from on-head to off-head, of the second earpiece.

18. The method of claim 17, further comprising determining which of the first earpiece and the second earpiece has changed from on-head to off-head according to which of a change in the first orientation signal and a change in the second orientation signal, over a period of time, is larger.

19. The method of claim 17, wherein beginning or suspending at least one function of the pair of earphones comprises beginning a pending call upon determining the change in the on-head status, from off-head to on-head, of at least one of the first earpiece or the second earpiece.

20. The method of claim 11, wherein determining an on-head status of the first earpiece and the second earpiece is further based on input from a sensor.
